(19) United States
(12) Patent Application Publication
(10) Pub. No.: US 2016/0287022 A1
(43) Pub. Date: Oct. 6, 2016

(54) Spill Proof Cutting Surface

(71) Applicants: Abigail Humphreys, Big Lake, MN (US); Carla Humphreys, Big Lake, MN (US); Samantha Humphreys, Big Lake, MN (US); Jazmin Humphreys, Big Lake, MN (US); John Humphreys, Big Lake, MN (US); Donald Humphreys, Big Lake, MN (US)

(72) Inventors: Abigail Humphreys, Big Lake, MN (US); Carla Humphreys, Big Lake, MN (US); Samantha Humphreys, Big Lake, MN (US); Jazmin Humphreys, Big Lake, MN (US); John Humphreys, Big Lake, MN (US); Donald Humphreys, Big Lake, MN (US)

(21) Appl. No.: 14/673,198

(22) Filed: Mar. 30, 2015

(51) Int. Cl. A47J 47/00

(52) U.S. Cl. CPC A47J 47/005

(57) ABSTRACT

The spill proof cutting surface includes; a cutting surface; and a flexible flange attached to the cutting surface. The flexible flange is bendable to create a rim around the cutting surface. The flexible flange is itself liquid proof and is attached to the cutting surface in a liquid proof manner.

### FIELD

This invention relates to the Culinary Arts, specifically to the cutting boards for food preparation.

### BACKGROUND

The provision of a food preparation surfaces which provides for liquid retention has been attempted in a number of ways. Provision of the rigid edge is exemplified by U.S. Pat. No. 7,300,103 to Grays and U.S. Pat. No. 7,201,445 to Dubial et al. In practice the rigid edges proved problematical for the user by inhibiting the use of a knife or other cutting instrument near the edges.

### SUMMARY

The spill proof cutting surface includes; a cutting surface; and a flexible flange attached to the cutting surface. The flexible flange is bendable to create a rim around the cutting surface. The flexible flange is itself liquid proof and is attached to the cutting surface in a liquid proof manner. The outer circumference of the flexible flange may be smaller than the inner diameter of the flexible flange so that the flexible flange will have a tendency stay in an elevated position relative to the cutting surface. The flexible flange is attached to the spill proof cutting surface by any suitable liquid proof.

### BRIEF DESCRIPTION OF DRAWINGS

FIG. 1 is a perspective view of an Oval spill proof cutting surface.

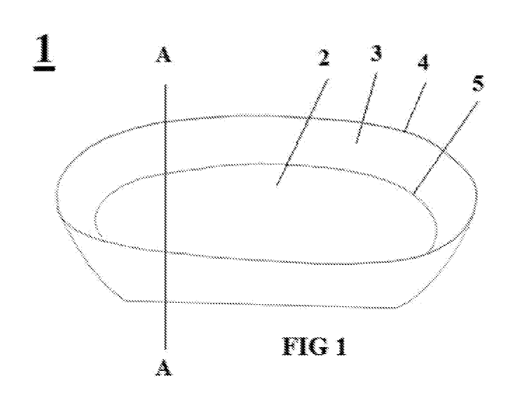

FIG. 2 is a perspective view of a Circular spill proof cutting surface.

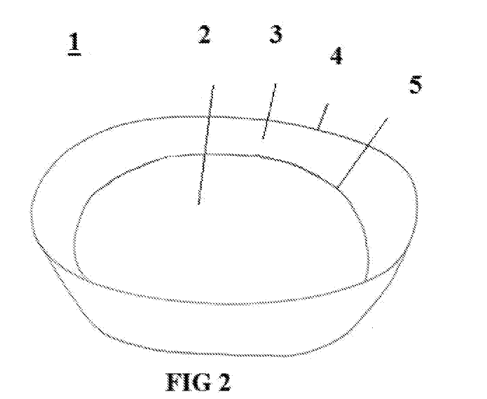

FIG. 3 is a perspective view of an Oval spill proof cutting surface with one or more openings.

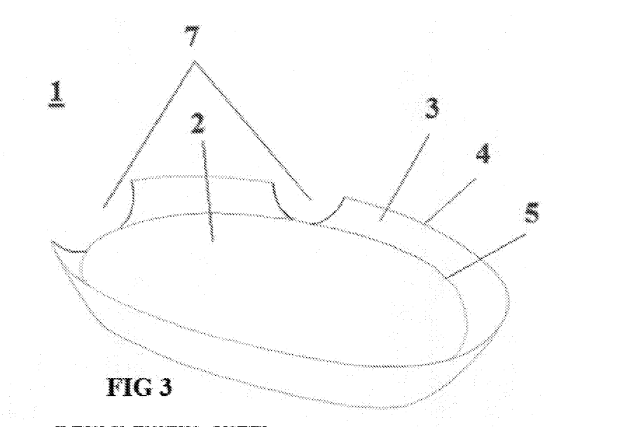

FIG. 4 is section view of an Oval Spill proof cutting surface along line AA of FIG. 1.

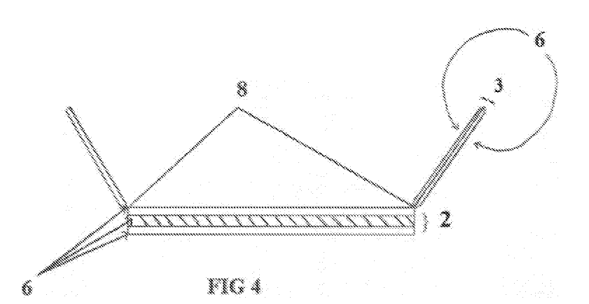

FIG. 5 is a perspective view of a rectangular spill proof cutting surface with rounded corners.

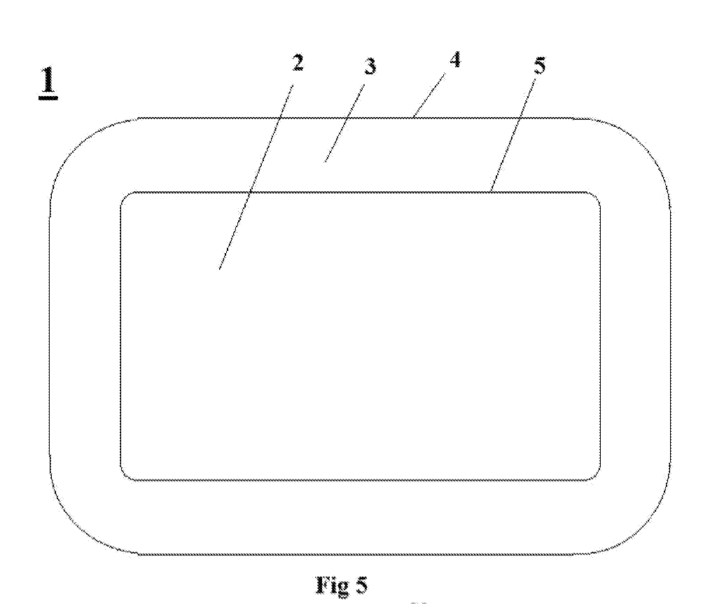

### DETAILED DESCRIPTION

The spill proof cutting surface 1 includes; a cutting surface 2; and a flexible flange 3 attached to the cutting surface 2. The flexible flange 3 is bendable to create a rim around the cutting surface 2. The flexible flange 3 is itself liquid proof and is attached to the cutting surface 2 in a liquid proof manner. The outer circumference 4 of the flexible flange 3 may be smaller than the inner diameter of the flexible flange 3 so that the flexible flange 3 will have a tendency stay in an elevated position relative to the cutting surface 2. The flexible flange 3 is attached to the spill proof cutting surface 1 by any suitable liquid proof method such as, but not limited to: a Living hinge 8, welding, fusing, stitching. The cutting surface 2 may be constructed of metal, plastic, wood or any liquid proof material. The cutting surface 2 may be constructed of one or more laminations 6 of similar or dissimilar materials. The cutting surface 2 may be of any shape chosen to facilitate the purpose of cutting and preparing food or to enhance esthetic appeal.

The flexible flange 3 may be constructed of plastic, wood, or metal and may be constructed of one or more laminations 6 of similar or dissimilar materials, provided that the flexible flange 3 is resilient enough to create a liquid proof rim around the circumference of the cutting surface 2. The flexible flange 3 is sufficiently resilient so that when a portion is depressed to or below the plane of the circumference of the cutting surface 2, the flexible flange 3 restores itself to its original rim shape. This deformability and resilience is to allow controlled drainage of the spill proof cutting surface 1 and restoration to a spill proof configuration. The flexible flange 3 and cutting surface 2 may be constructed of a single piece of material, or materials, in this configuration the connection between the cutting surface 2 and the flexible flange 3 is accomplished by a thin region connecting the flexible flange 3 and cutting surface 2 by forming a thin region known as a living hinge 8.

The flexible flange 3 may completely surround the circumference of cutting surface 2 or may have one or more openings 7.

What is claimed is:

1.-19. (canceled)

20. An article comprising:
a cutting surface having a perimeter; and
a flexible flange having an inner circumference and an outer circumference, the inner circumference directly attached to the perimeter of the cutting surface,
wherein the outer circumference of the flexible flange is smaller than the inner circumference, and
wherein the flexible flange is bendable and creates a rim around the perimeter of the cutting surface.

21. An article according to claim 20, wherein the flexible flange is featureless.

22. An article according to claim 20, wherein the flexible flange is attached to the perimeter of the cutting surface by welding, fusing, or stitching.

23. An article according to claim 20, wherein the cutting surface comprises at least one of metal, plastic, or wood.

24. An article according to claim 20, wherein the cutting surface is liquid proof.

25. An article according to claim 20, wherein the cutting surface comprises a laminate.

26. An article according to claim 20, wherein the flexible flange comprises at least one of plastic, wood, or metal.

27. An article according to claim 20, wherein the flexible flange comprises a laminate.

28. An article according to claim 20, wherein the rim around the perimeter of the cutting surface is liquid proof.

29. An article according to claim 20, wherein the flexible flange is sufficiently resilient to restore itself to its original shape when a portion is depressed to or below the plane of the circumference of the cutting surface.

30. An article according to claim 20, wherein the flexible flange comprises one or more openings in the outer circumference.

31. An article according to claim 20, wherein the cutting surface is substantially circular, oval, or rectangular.

32. An article comprising:
a cutting surface having a perimeter;
a flexible flange having an inner circumference and an outer circumference, the inner circumference directly attached to the perimeter of the cutting surface,
wherein the outer circumference of the flexible flange is smaller than the inner circumference, and
wherein the flexible flange is bendable and creates a rim around the perimeter of the cutting surface; and
a living hinge,
wherein the living hinge comprises a thin region connecting the perimeter of the cutting surface with the inner circumference of the flexible flange.

33. An article according to claim 32, wherein the flexible flange, the cutting surface, and the living hinge are made of the same material or materials.

34. An article according to claim 32, wherein the flexible flange is featureless.
